(19) United States
(12) Patent Application Publication
(10) Pub. No.: US 2016/0281921 A1
(43) Pub. Date: Sep. 29, 2016

(54) Tackclip and Tackhook Devices

(71) Applicant: Dale Keith Painter, Bakersfield, CA (US)

(72) Inventor: Dale Keith Painter, Bakersfield, CA (US)

(21) Appl. No.: 15/087,977

(22) Filed: Mar. 31, 2016

Related U.S. Application Data
(60) Provisional application No. 62/125,804, filed on Feb. 2, 2015.

(51) Int. Cl. F16M 13/02; F16B 45/00; A47G 1/20; F16B 2/24

(52) U.S. Cl. CPC F16M 13/022; F16B 2/24; F16B 45/00; A47G 1/20

(57) ABSTRACT

Devices having clip mechanisms or hooks and built-in fasteners for securing notes, documents, photographs and other items to vertical surfaces are disclosed. The devices of the present invention typically include a back plate, a clip mechanism or hook to hold one or more documents and/or items without causing damage to the documents or items, one or more fasteners, typically built into the back plate for securing the device and the documents or items to a vertical surface. In addition, the devices may advantageously provide for the fasteners to be rotated into and out of the back plate so that when the devices are not attached to surfaces, they can be easily stored without potential harm to the packaging or containers, or to the items fastened to the devices.

### FIELD OF THE INVENTION

The present invention generally relates to the field of attachment devices. Specifically, embodiments of the present invention relate to devices that securely hold notes, documents, photos and other items and attach such items to porous and non-porous surfaces without causing damage to the items.

### DISCUSSION OF THE BACKGROUND

Countless clipping devices are available on the market today as are a multitude of fastening devices. However, typical fastening devices, such as thumb tacks, pins, nails, etc., that are typically used for securing notes, documents, photographs and other items to vertical surfaces such as sheet rock walls, cork boards, wood, etc., put holes in the items, and thus, damage them. Likewise tapes or adhesives do not allow notes, documents, photos, etc. to be removed from the vertical surface without the potential for damage caused by tearing or peeling of the notes, documents, photos, etc.

Further, available devices for clipping or hooking notes, documents, photos and other items to vertical surfaces have separate fasteners, which are easily misplaced or may be the wrong type for the particular surface composition on which the items are to be secured.

Thus, there is a need for simple, economical devices that can securely hold notes, documents, photographs and other items to vertical surfaces, such as sheet rock, cork board, and other porous and non-porous surfaces that do not damage the item being secured. There is also a need for simple, economical devices that have built-in fasteners so that the fasteners are not misplaced or lost before or during the process of attachment to the vertical surface, and which are appropriate for the type of items being secured.

### SUMMARY OF THE INVENTION

The present invention advantageously provides a tackclip having at least one fastening device, the fastening device typically built into a back plate of the tackclip, and having a clip mechanism to hold notes, sheets of paper of standard and irregular sizes, multiple documents, posters and/or other items without damage to the items.

In an embodiment of the present invention, a tackclip device is provided having a back plate, a spring and a clip mechanism configured to hold one or more items against the back plate without damage, and at least one fastener inserted though and/or attached to the back plate, the fastener configured to secure the device to a surface so that the device and items held by the device are at least temporarily attached and/or fastened to the surface.

In another embodiment, a device is provided having a back plate, a spring and a clip mechanism configured to hold one or more items without damage, and also having a torque shaft recessed into a torque channel in the back plate, two or more fasteners attached and/or connected to the torque shaft, and a handle to rotate the torque shaft and the two or more fasteners into and out of recessed fastener channels in the back plate.

In a further aspect, in lieu of a spring and clip mechanism, the device may have a back plate and one or more hooks that may be attached to and/or pressed into the back plate, the hooks configured to hold one or more objects without damaging the objects, and at least one fastener inserted through and/or attached to the back plate to secure the device to a surface.

A more complete understanding of the tackclip device will be afforded to those skilled in the art, as well as a realization of additional advantages and objects thereof, by consideration of the following detailed description of preferred embodiments. Reference will be made to the appended sheets of drawings, which will first be described briefly.

### BRIEF DESCRIPTION OF THE DRAWINGS

FIG. 1A is a front view of a light-duty tackclip having a single built-in fastener, according to an embodiment of the present invention.

FIG. 1B is a side view of the light-duty tackclip of FIG. 1A showing a clip mechanism and a spring for operating the clip mechanism.

FIG. 2A is a front view of a medium-duty tackclip having an elongated clip and a single built-in fastener, according to an embodiment of the present invention.

FIG. 2B is a side view of the medium-duty tackclip of FIG. 2A showing a clip mechanism and a spring for operating the clip mechanism.

FIG. 3A is a front view of a heavy-duty tackclip having two built-in fasteners and an elongated clip, according to an embodiment of the present invention.

FIG. 3B is a side view of the heavy-duty tackclip of FIG. 3A, showing a clip mechanism and a spring for operating the clip mechanism.

FIG. 4A is a partial back view of a tackclip showing a torque shaft in a torque channel and two fastener channels in the back plate of the tackclip, according to an embodiment of the present invention.

FIG. 4B is a section view of the tackclip of FIG. 4A showing the torque shaft, a handle and two fasteners.

FIG. 4C is a section view of the tackclip of FIG. 4A showing the torque shaft and the torque channel.

FIG. 4D is a section view of the tackclip of FIG. 4A showing one of the fastener channels.

FIG. 5A is a front view of a tackhook having a built-in fastener, according to an embodiment of the present invention.

FIG. 5B is a side view of the tackhook of FIG. 5A showing an attached hook.

FIG. 6A shows a front view of an elongated tackhook, having four hooks and two built-in fasteners.

FIG. 6B is a side view of the tackhook of FIG. 6A showing the backplate, a hook and a built-in fastener.

FIG. 7 is a section view of a back plate of a tackclip with a fastener inserted into a surface, according to an embodiment of the present invention.

### DETAILED DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications, and equivalents that may be included within the spirit and scope of the invention. Furthermore, in the following detailed description of the present invention, numerous specific details are set forth in order to provide a thorough understanding of the present invention. However, it will readily be apparent to one skilled in the art that the present invention may be practiced without these specific details. These conventions are intended to make this document more easily understood by those practicing or improving on the inventions, and it should be appreciated that the level of detail provided should not be interpreted as an indication as to whether such instances, methods, procedures or components are known in the art, novel, or obvious.

Embodiments of the present invention include devices configured to hold notes, sheets of paper of standard and odd sizes, photographs, documents, posters and/or other items. Embodiments include, but are not limited to, a simple tackclip with a hole to allow it to be attached to a porous surface with a thumb tack, pin, nail or other fastener separate from the clip mechanism, a tackclip with a sharp pin built into the device with a suitable head to allow the tackclip to be inserted into a porous surface with thumb pressure, a mallet (rubber or otherwise), a hammer etc., and a tackclip with two or more sharp fasteners built into the device to prevent rotation and to carry additional weight of documents compared to the weight carried by a single fastener.

In one embodiment, a tackclip, having recessed channels in the rear of back plate and one or more fasteners, comprises a rotatable handle connected and/or coupled to a torque shaft. The one or more fasteners are attached to the torque shaft such that when the handle is rotated in one direction, the fasteners rotate down and/or into the recessed fastener channels in the back plate, and when the handle is rotated in the opposite direction, the fasteners are rotated up and/or out of fastener channels in the back plate.

In yet another embodiment, in lieu of a clip, a hook or series of hooks are attached and/or connected to the back plate for hanging one or multiple items (e.g., a picture, neck ties, keys, etc.).

Regardless of the configuration, embodiments of the present invention advantageously provide tackclip and tackhook devices that are economical and securely attach notes, documents, photos, etc. to corkboard, sheetrock and other porous (and in some embodiments, non-porous) surfaces without damage to the items. The invention, in its various aspects, will be explained in greater detail below with regard to exemplary embodiments.

### Exemplary Tackclip Devices

Light-duty Tackclip:

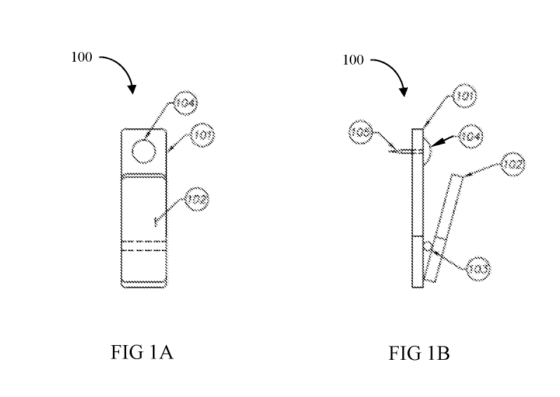

Referring now to FIGS. 1A and 1B, therein is shown an exemplary light-duty tackclip 100 having back plate 101, a clip mechanism 102, a spring 103, and a built-in fastening device 105 in the back plate 101. The spring 103 is configured for operating the clip mechanism 102 relative to the back plate 101 such that the clip mechanism 102 holds one or more items (e.g., notes, photographs, documents and/or other items, not shown) against the back plate 101 without causing damage to the objects.

The clip mechanism 102, of the exemplary tackclip 100 of FIGS. 1A and 1B, is configured such that a width of the clip mechanism 102 is the same as a width of the back plate 101. However, in other embodiments, the width of the clip mechanism 102 may be wider or narrower than the back plate 101. The exemplary tackclip 100 also is shown to have only one fastener. However, in other embodiments, the tackclip may have more than one fastener.

The exemplary tackclip 100 is configured to have a built-in or “integral” fastener, having a fastener head 104, which is permanently attached and/or connected to the back plate 101. The built-in fastener 105 is configured for convenience, and ease of use as it eliminates the need to look for the appropriate type/style of fastener, and eliminates dropping and/or losing the fastener(s) before or when securing the tackclip 100 to a vertical surface. The built-in fastener 105 may be permanently attached and/or connected to the back plate 101 by molding or casting the fastener 105 into the material of the back plate at the time of manufacture, or alternatively, by fusing, welding, brazing, tacking, etc., the head 104 of the fastener to the back plate 101.

In some embodiments, the head 104 of the built-in fastener 105 in the front view is round, and of a diameter such that the tackclip may be inserted into a porous surface using simple thumb pressure. In other embodiments, the head 104 of the fastener may be square or some other shape that facilitates ease of use. In cross-section, and as shown in FIG. 1B, the head 104 may be approximately semi-circular. In other embodiment, the cross-section of the head 204 may be square or rectangular and may, in some instances be a combination of shapes. In any case, in some instances the head 104 is constructed such that it may be struck with a mallet (rubber or otherwise), a hammer, etc., without damage and in order to drive the fastener 105 of tack clip 100 into a non-porous (or porous) surface.

In an alternate embodiment, in lieu of a built-in fastener, the back plate 101 may have a hole through the plate, sized appropriately to accept a standard thumb tack or other fastener (e.g., a nail, screw, wood screw, bolt, pin, etc.). In such embodiments, the hole is sized to have the same or slightly larger diameter than the fastener to be inserted therein. For example, if a standard thumbtack has a pin diameter of 1/32″ (0.0312″), the hole may be sized at from 1/32″ to 3/64″ in diameter. In other instances, the diameter of the through hole may be sized at from 1/64″ to 1/32″ larger than fastener 105. In any case, the diameter of the hole may range from 1/32″ to ⅜″ (e.g., 1/32″, 3/64″, 1/16″, ⅛″, 3/16″, ¼″, 5/16″, etc.).

In the exemplary embodiment of FIGS. 1A/1B, the width of the back plate and width of the clip mechanism are the same, and may range from about ½″ to about 2½″ (e.g., ½″, ⅝″, ¾″, 1″, 1⅛″, 1½″, 1 9/16″, 2¼″, etc.) or more. Typically, the light-duty tackclip of FIGS. 1A/1B will have a width in the lower end of the above range of widths. The height of the tackclip of FIGS. 1A and 1B may range from about 1″ to 3″ (e.g., 1″, 1¼″, 1¾″, 2½″, 2⅞″, etc.).

The back plate 101 and clip mechanism 102 may be made from any suitable material. For example, the back plate 101 and clip mechanism 102 may be made from one or more plastics (e.g., high-density polyethylene, polypropylene, polyurethane, etc.), nylon, one or more metals (e.g., steel, steel alloys, carbon steel, aluminum, aluminum alloys, etc), fiberglass, etc., or a combination thereof. If metal or a metal alloy is used, the metal may be coated or plated with any suitable conventional coating or plating material.

The spring 103 most typically is a torsion spring constructed of steel, a steel alloy, stainless steel, music wire or may be hard drawn. The spring 103 may be coated or uncoated, and the coating may comprise zinc, black oxide, gold iridite, or other coating known in the industry. The internal diameter (ID) of the spring 103 may have a diameter of from 5/64″ (0.078″) to ⅜″ (0.375″) and an outside diameter (OD) of about 3/32″ (0.094″) to ½″ (0.500″) and may be in any suitable length, depending upon the width of the back plate 101. Most typically, the spring 103 of the light-duty tackclip 100 comprises a spring with ID/OD's in the lower portion of the above ranges of diameters.

Medium-duty Tackclip:

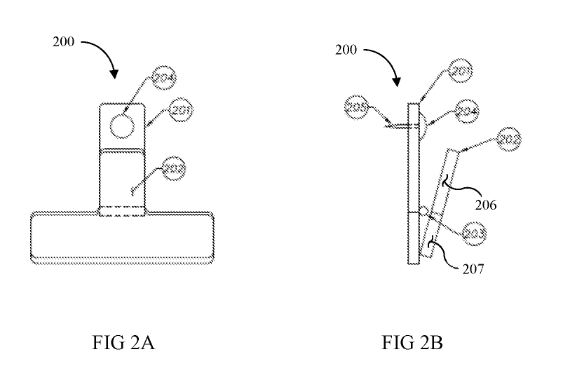

FIGS. 2A and 2B shows a medium-duty embodiment of a tackclip 200 comprising a back plate 201, a clip mechanism 202, a spring 203, and a built-in fastener 205 that is permanently attached and/or connected to the back plate 201 and having a head 204. The medium-duty tackclip 200 is similar in construction to the light-duty tack clip of FIGS. 1A/1B except that it is typically larger and is capable of holding larger and/or heavier items.

Similar to the built-in fastener 105 of FIGS. 1A/1B, built-in fastener 205 eliminates the need to look for the appropriate type/style of fastener, and eliminates dropping and/or losing the fastener(s) before or when securing the tackclip 200 to a surface. The built-in fastener 205 may be permanently attached and/or connected to the back plate 201 in the same manner as the built-in fastener 105 (i.e., by molding or casting the fastener 205 into the material of the back plate, or alternatively, by fusing, welding, brazing, tacking, etc., the head 204 of the fastener to the back plate 201).

The head 204 of the built-in fastener 205 may have the same shapes as described above for head 104 of fastener 105, namely, round, square or some other shape that facilitates ease of use. In cross-section, the head 204 may be approximately semi-circular or may be approximately square or rectangular, or the cross-section may be some combination of shapes. In some instances, the head 204 is constructed such that it may be struck with a mallet (rubber or otherwise), a hammer, etc., without damage in order to drive the tack clip 200 into a non-porous (or porous) surface.

In the embodiment of FIGS. 2A and 2B, the clip mechanism comprises a clip mechanism 202, with the spring 203, the spring configured to facilitate operation of the clip plate 202 in relationship to the back plate 202. As with the light-duty tackclip described above, the medium-duty tackclip most typically comprises a torsion spring made of the same materials as described above for the light-duty tackclip. Most typically, the medium-duty tackclip 200 has a spring with and ID/OD in the middle of the ranges of diameters described above.

The width of the back plate 201 and width of a top portion 206 of the clip mechanism 202 may be the same, and may range from about ½″ to about 2″ (e.g., ½″, ⅝″, ¾″, 1″, 1⅛″, 1½″, 1 9/16″, etc.) or more. The height of the tackclip 200 may range from about 1″ to 3″ (e.g., 1″, 1¼″, 1¾″, 2½″, 2⅞″, etc.). Typically, the medium-duty tackclip 200 has a width in the mid-range of the widths above.

As shown in FIG. 2A the width of a bottom portion 207 of the clip mechanism 202 is wider than the width of the back plate 201. The clip mechanism 202 is configured in this manner so as to hold larger and/or heavier documents securely. The width of the bottom portion 207 may range from 2″ to 6″ (e.g., 2″, 2⅜″, 3¼″, 4 5/16″, 5½″, etc.) or more.

Similar to the light-duty tackclip 100 of FIGS. 1A/1B, the medium duty tackclip 200, the back plate 201 and clip mechanism 202 may be made from any suitable material. For example the back plate 201 and clip mechanism 202 may be made from one or more plastics (e.g., high-density polyethylene, polypropylene, polyurethane, etc.), nylon, one or more metals (e.g., steel, steel alloys, carbon steel, aluminum, aluminum alloys, etc), fiberglass, etc., or a combination thereof. If metal or a metal alloy is used, the metal may be coated or plated with any suitable conventional coating or plating material.

Heavy-duty Tackclip

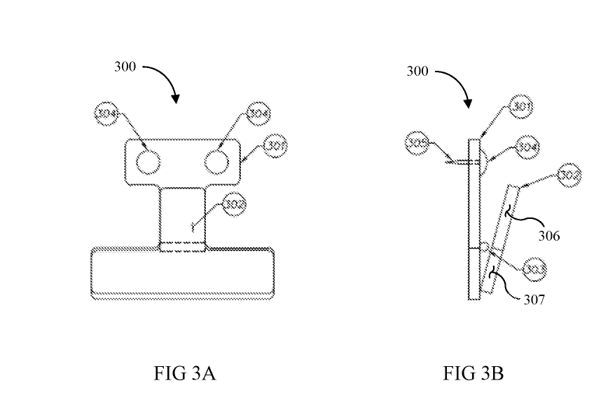

Referring now to FIGS. 3A/3B, therein is shown a heavy-duty tackclip 300 comprising a back plate 301, a clip mechanism 302, a spring 303, and two built-in fasteners 305, each having fastener heads 304. The heavy-duty tackclip of FIGS. 3A/3B is similar in construction to the light-duty tack clip 100 of FIGS. 1A/1B and the medium-duty tackclip 200 of FIGS. 2A/2B, except that it is typically even larger, and is capable of holding even larger and/or heavier items than the medium-duty tackclip of FIGS. 2A/2B.

The built-in fasteners 305 are similar to the built-in fastener 205 of FIGS. 2A/2B, except that in the exemplary embodiment of FIGS. 3A/3B, there are two fasteners 305, which are configured to prevent rotation and/or to carry additional weight in comparison to the medium-duty tackclip. The built-in fasteners 305 may be permanently attached to the back plate 301 in the same manner as the built-in fastener 205 of FIGS. 2A/2B, and embodiments of the tackclip 300 may have the same types and/or shapes of heads 304 as those of head 204.

In the embodiment of FIGS. 3A/3B, and similar to the embodiment of FIGS. 2A/2B, the tackclip comprises a clip mechanism 302, with the spring 303 between the back plate 301 and the spring 303, configured to facilitate operation of the clip plate 302 in relationship to the back plate 301. As with the medium and light-duty tackclips described above, the heavy-duty tackclip most typically comprises a torsion spring made of the same materials as described above. Most typically, the heavy-duty tackclip 300 has a spring with and ID/OD in the high end of the ranges of diameters described above.

The width of the back plate 301 and width of a top portion 306 of the clip mechanism 302 may be the same, and may range from about ½″ to about 2″ (e.g., ½″, ⅝″, ¾″, 1″, 1⅛″, 1½″, 1 9/16″, etc.) or more. The height of the tackclip of FIGS. 1A and 1B may range from about 1″ to 3″ (e.g., 1″, 1¼″, 1¾″, 2½″, 2⅞″, etc.). Typically, the heavy-duty tackclip 300 has a width at the high end of the range of the widths above.

Like the medium-duty tackclip 200, the heavy-duty tackclip 300 has a width of a bottom portion 307 of the clip mechanism 302 that is wider than the back plate 301. The bottom portion 307 of the clip mechanism 302 is configured in this manner so as to even hold larger and/or heavier documents securely. The width of the bottom portion 307 may range from 2″ to 6″ (e.g., 2″, 2⅜″, 3¼″, 4 5/16″, 5½″, etc.) or more, and the heavy-duty tackclip 300 is most typically at the high end of the range of widths for the tackclips.

Similar to the light-duty tackclip 100 of FIGS. 1A/1B and the medium duty tackclip 200 of FIGS. 2A/2B, the back plate 301 and clip mechanism 302 may be made from any suitable material. For example the back plate 301 and clip mechanism 302 may be made from one or more plastics (e.g., high-density polyethylene, polypropylene, polyurethane, etc.), nylon, one or more metals (e.g., steel, steel alloys, carbon steel, aluminum, aluminum alloys, etc), fiberglass, etc., or a combination thereof. If metal or a metal alloy is used, the metal may be coated or plated with any suitable conventional coating or plating material.

Tackclip with Rotatable Fasteners:

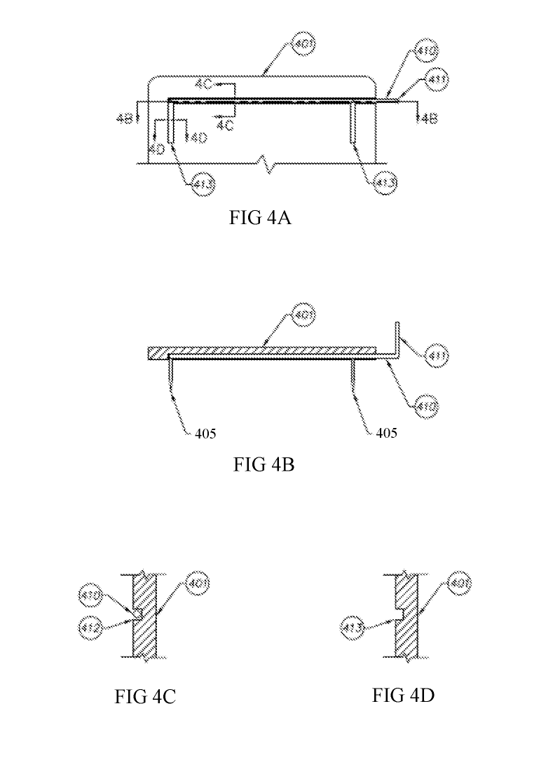

Referring now to FIGS. 4A-4D, and more specifically to FIG. 4A, therein is shown a ear view of a portion of the back plate 401 having rotatable fasteners 405 configured to be rotated into recessed fastener channels in the back plate so that the notes, documents, photographs and/or other items, while clipped together but not attached to a surface, may be placed in an envelope, file, briefcase or other package or container without harm to the package or container, or the items held by the tackclip.

As shown in the embodiment of FIGS. 4A-4D, the back plate 401 has a torque shaft 410, two built-in fasteners 405 attached and/or connected to the torque shaft 410, and handle 411, also connected to the torque shaft 410 at one end, and extending beyond the back plate 401. Although the embodiment of FIGS. 4A-4D is shown with two fasteners 405, the tackclip may comprise any reasonable number of fasteners (e.g., 2, 3, 4, 5, etc.), depending on the weight of documents or objects the tackclip is expected to hold.

As shown in FIGS. 4C and 4D, the torque shaft 410 rotates in a recessed torque channel 412, which is approximately perpendicular to two fastener channels 413, which are configured to accept the fasteners 405 such that when handle 411 is rotated in one direction, the fasteners 405 rotate into the fastener channels 413 in back plate 401 such that the fasteners are below the surface of the back plate. When the handle 411, is rotated in the opposite direction, the fasteners 405 rotate out of the fastener channels 413 in the back plate 401, such that fasteners are in the position shown in FIG. 4B.

The built-in fasteners 405 are similar to the built-in fastener 305 of FIGS. 3A/3B, except that in the exemplary embodiment of FIGS. 4A/4B, the two fasteners 405 are attached and/or otherwise connected to the torque shaft 410. Like the built-in fasteners of FIGS. 3A/3B, the fasteners are configured to be inserted into a porous or non-porous surface and are configured to prevent rotation of the back plate 401 and/or to carry additional weight in comparison to a single fastener tackclip. The fasteners 405 may be pins, nails, or other sharp-ended fasteners, permanently attached to the torque shaft 410 by fusing, welding, brazing, tacking, etc.

In some embodiments, and as shown in FIG. 4D, the torque shaft 410 may be configured to snap into an approximately square cross-sectional torque channel 412 recessed into the back plate 401. In such embodiments, the width of the torque channel 412 may be approximately the same as the diameter of the torque shaft 410. In other embodiments, the torque shaft 410 may be retained inside a torque channel 412 that has a width larger than the diameter of the torque shaft 410 by retaining clips and/or miniature bearings or machined bushings (not shown). The torque shaft 410 may be constructed of steel, a steel alloy, stainless steel, aluminum, an aluminum alloy, or any other suitable conventional material known in the industry, and may be coated and/or plated to facilitate rotation of the torque shaft 410 within the torque channel 412.

The rotation of the torque shaft is controlled by the movement of handle 411. In some embodiments, the handle 411 may be made of the same material as the material of the torque shaft 410, or in other embodiments, may be a different material altogether. In some embodiments, the torque shaft 410 and handle 411 may both be carbon steel or aluminum, and may be a single round bar bent at appropriate location such that the handle 411 extends beyond the torque channel 412 and may be at about a 90 degree angle to the torque shaft 410. In other instances, the handle may be made separately, and then connected to the torque shaft by tacking, welding, brazing, soldering, fusing, pinning, screwing etc. Further, and although the handle is shown to be a straight member at about a 90 degree angle to the torque shaft, the handle may be another configuration, such as curved, a “U” shape, an “S” shape, and may have a tip or end that is rubber or plastic for ease of grasping and/or rotating.

The torque channel 412 may have a square, rectangular or semi-circular cross-section, or a combination thereof. Likewise, the fastener channels 413 may also have a cross-section that is square, rectangular, semi-circular or combination thereof. The width of the fastener channels is most typically slightly ( 1/64″ to ⅛″) larger that the diameter of the fasteners.

Tackhook:

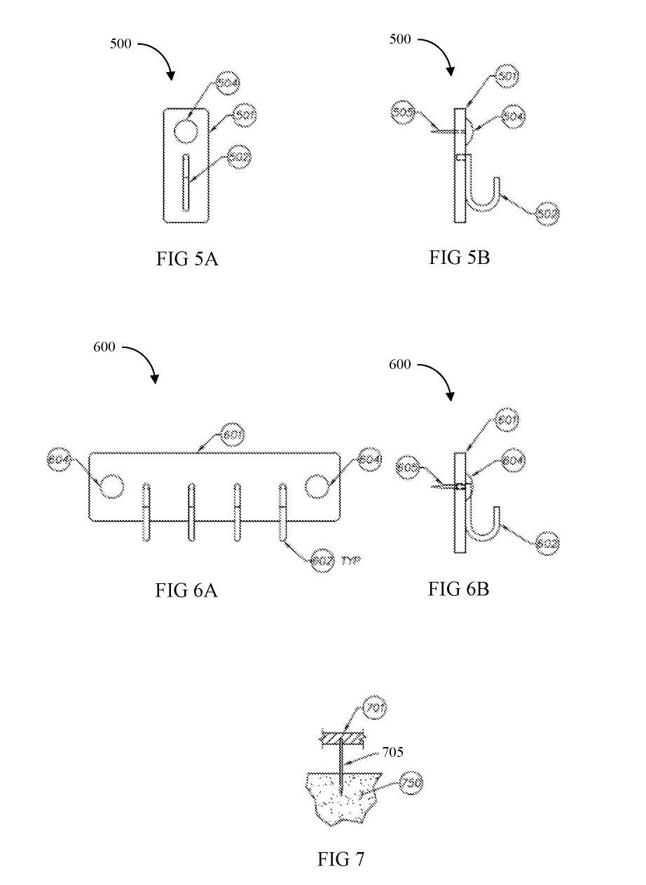

In FIGS. 5A and 5B is shown an exemplary tackhook 500 according to an embodiment of the present invention, comprising a back plate 501, a built-in fastener 505 and a hook 502. The hook 502 replaces the clip of the previous embodiments and is configured such that pictures, keys, neckties and/or other objects may be hung from the hook 502. The hook 502 may be pressed into the back plate 501, or may be attached by fusing, welding, brazing, tacking, etc. In some embodiments, particularly where the objects to be hung are lightweight, the hook 502 may be adhered to the backplate 501 with glue and/or other adhesive.

Although the embodiment of FIGS. 5A and 5B show a single hook 502, in other embodiments, such as the embodiment shown in FIGS. 6A and 6B, the tackhook may have a plurality of hooks 602 spaced apart, and may comprise two built-in fasteners 605. In the embodiment of FIGS. 6A and 6B, the fasteners 605 are shown approximately centered vertically on the tackhook. However, in other embodiments, the fasteners may be located above a horizontal centerline and may be spaced closer together than the fasteners 605 shown in FIG. 6B.

The back plate 501 or 601 may be made from any suitable material including, but not limited to, one or more plastics (e.g., high-density polyethylene, polypropylene, polyurethane, etc.), nylon, one or more metals (e.g., steel, steel alloys, carbon steel, aluminum, aluminum alloys, etc), fiberglass, wood, etc., or a combination thereof. Similarly, hooks 502 and 602 may be made from the one or more plastics, nylon, one or more metals, fiberglass, wood, etc., and may be made from the same material as the back plates 501 or 601, or one or more different materials.

Referring now to FIG. 7, therein is shown a partial sectional view of an exemplary back plate 701 having a single fastener 705 inserted into a porous material 750. The back plate may be made of one or more of the materials described above for other embodiments. Also, as indicated above, the fastener 705 may be sharp-ended (e.g., a pin, nail, needle, etc.) to provide for ease of insertion into a porous material (e.g. corkboard, cardboard, drywall, etc.). In some embodiments, the fastener may be inserted into a non-porous material (e.g., wood, plastic, etc.) using a mallet, hammer, or other method of driving such fasteners into non-porous surfaces.

### CONCLUSION

Embodiments of the present invention advantageously provide simple devices that securely hold documents and/or other items, and attach such documents or items to corkboard, sheet rock, and other porous and non-porous surfaces via one or more fasteners, without damaging the documents and/or other objects.

The foregoing descriptions of specific embodiments of the present invention have been presented for purposes of illustration and description. They are not intended to be exhaustive or to limit the invention to the precise forms disclosed. Obviously, many modifications and variations are possible in light of the above teaching. The embodiments were chosen and described in order to best explain the principals of the invention and its practical application, to thereby enable others skilled in the art to best utilize the invention and the various embodiments and modifications as are suited to the particular use contemplated. It is intended that the scope of the invention be defined by the components and elements described herein and their equivalents.

What is claimed is:

1. A device, comprising:
a back plate;
a clip mechanism configured to hold one or more documents and/or items without causing damage to the documents and/or items;
a spring configured for operating the clip mechanism relative to the back plate;
at least one fastener inserted through and/or attached to the back plate, wherein the at least one fastener is configured to secure the device to a surface such that the device and documents and/or items held by the clip mechanism are at least temporarily attached and/or fastened to the surface.

2. The device of claim 1, further comprising at least one hole in the back plate, wherein the at least one fastener is separate from the base plate and is inserted through the at least one hole.

3. The device of claim 1, wherein the at least one fastener is built-in and/or permanently attached to the base plate.

4. The device of claim 3, wherein the at least one fastener comprises two fasteners.

5. The device of claim 3, wherein a width of at least a portion of the clip mechanism is greater than a width of the back plate.

6. The device of claim 3, wherein the width of the clip mechanism is the same as the width of the back plate.

7. The device of claim 1, wherein the back plate and clip mechanism are plastic, nylon, fiberglass or metal, or a combination thereof.

8. A device, comprising:
a back plate;
a clip mechanism configured to hold one or more documents and/or items without causing damage to the documents and/or items;
a spring configured for operating the clip mechanism relative to the back plate;
a torque shaft recessed into a torque channel in the back plate;
two or more fasteners attached and/or connected to the torque shaft, the two or more fasteners configured to be secured to a surface such that the device and the documents and/or items held by the clip mechanism are at least temporarily attached and/or fastened to the surface;
a handle attached and/or connected to the toque shaft at one end, the handle configured to (i) rotate the torque shaft in one direction such that each of the two or more fasteners rotate into a fastener channel in the back plate, and (ii) rotate the torque shaft in an opposite direction such that each of the two or more fasteners rotate out of the fastener channel in the back plate.

9. The device of claim 8, wherein the handle is formed by bending an end of the torque shaft that extends out of the back plate at a 90 degree angle.

10. The device of claim 8, wherein the torque shaft snaps into the back plate.

11. The device of claim 8, wherein the torque channel and fastener channels have a square cross-section.

12. The device of claim 8, wherein the fastener channels have a rectangular cross-section.

13. The device of claim 8, wherein the back plate and the clip mechanism are plastic.

14. The device of claim 8, wherein the back plate and clip mechanism are metal, a metal alloy or a combination thereof.

15. A device, comprising:
a back plate;
at least one hook configured to hold one or more items without causing damage to the items;
at least one fastener inserted through and/or attached to the back plate, wherein the at least one fastener is configured to be secured to a surface such that the device and items held by the hook are at least temporarily attached and/or fastened to a surface.

16. The device of claim 15, further comprising at least one hole in the back plate, wherein the at least one fastener is separate from the base plate and is inserted through the at least one hole.

17. The device of claim 16, wherein the at least one fastener is a thumb tack.

18. The device of claim 15, wherein the at least one fastener is built-in and/or permanently attached to the base plate.

19. The device of claim 15, wherein the at least one fastener comprises two fasteners.

20. The device of claim 15, wherein the hook is pressed into the base plate.
